(19) United States
(12) Patent Application Publication
(10) Pub. No.: US 2020/0276506 A1
(43) Pub. Date: Sep. 3, 2020

(54) TOY REMOTE CONTROLLER AND TOY WITH THE SAME

(71) Applicant: Shenzhen Qiandai Innovative Electronic Technology Co., Ltd., Shenzhen (CN)

(72) Inventor: Tianrong HUANG, Shenzhen (CN)

(21) Appl. No.: 16/288,123

(22) Filed: Feb. 28, 2019

(51) Int. Cl. A63H 30/04; G10L 25/87; G10L 15/22

(52) U.S. Cl. CPC A63H 30/04; G10L 15/22; G10L 25/87

(57) ABSTRACT

The present disclosure provides a toy remote controller and a toy with the same. The toy remote controller includes a housing, a gravity sensor, a voice sensor, a control circuit, and a display unit. The gravity sensor is located at a middle portion of the housing. The control circuit receives a control signal through the gravity sensor or the voice sensor to generate a control signal. The display unit is mounted upon the housing. The display unit is coupled to the control circuit and changes a display color according to the control signal. The present disclosure is capable of remotely controlling the toy by means of voice or shaking the toy remote controller, thereby realizing one-hand operation of the remote controller.

### BACKGROUND

### 1. Technical Field

The present disclosure relates to toy control technology, and particularly to a toy remote controller and a toy with the same.

### 2. Description of Related Art

Many existing toys such as toy airplanes, toy cars, or other sports toys are equipped with a remote controller for controlling its movement. Conventional remote controllers generally use joysticks to perform controlling and both hands are required to hold the remote controller at the same time, which are generally provided with two joysticks and require the user to use both hands cooperatively. Since they require the user to operate with both hands at the same time to control the movement of a toy, which is complex in their operation, and all the movements of the toy can only be controlled by pushing the joysticks, hence their operations are monotonous.

Simultaneously, for the remote controller using speech recognition technology, since there are certain differences between the speech recognition and the actual operation, the user can not accurately know the actual situation of control.

### SUMMARY

In order to solve the problem that the existing remote controllers have monotonous operation manners and the user can not know the actual situation of control, the present disclosure provides a toy remote controller and a toy with the same.

The present disclosure is achieved by the technical solutions as follows.

A toy remote controller including: a display unit; a gravity sensor; a voice sensor; a control circuit, where the display unit is electrically coupled to the control circuit; and a housing, where the display unit is mounted upon the housing, the gravity sensor, the voice sensor, and the control circuit are mounted within the housing, the gravity sensor is located at a middle portion of the housing; where, the control circuit receives information through the gravity sensor or the voice sensor to generate a control signal, and the display unit changes a display color according to the control signal.

Furthermore, the toy remote controller further includes: a power supply unit providing power to the toy remote controller; and a signal transmitting unit electrically coupled to the control circuit, where the signal transmitting unit transmits the control signal to a toy paired with the toy remote controller; where, the control circuit generates the control signal based on a gesture change information of a user obtained through the gravity sensor or based on a voice information of the user obtained through the voice sensor.

Furthermore, the toy remote controller further includes a switch mounted upon the housing, where the switch selectively turns on and turns off the toy remote controller, and the switch further selectively switches the control circuit to generate the control signal through the gravity sensor or selectively switches the control circuit to generate the control signal through the voice sensor.

Furthermore, the toy remote controller further includes a speed control circuit electrically coupled to the control circuit.

Furthermore, the speed control circuit includes a pressure detecting unit; where the pressure detecting unit obtains a pressure signal corresponding to a hand pressure of a user on the housing and transmits the pressure signal to the control circuit, and the control circuit obtains a speed control signal according to the pressure signal and transmits the speed control signal to a toy paired with the toy remote controller to control a movement speed of the toy.

Furthermore, the speed control circuit includes an angle detecting unit mounted within the housing; where the angle detecting unit detects an angle of inclination or swing of a top end of the housing to obtain a corresponding angle signal, and transmits the angle signal to the control circuit; the control circuit processes the angle signal to obtain a speed control signal, and transmits the speed control signal to a toy paired with the toy remote controller to control a movement speed of the toy.

Furthermore, the housing has a rod-like shape.

Furthermore, the display unit includes a display light; where the display light indicates the control signal in the control circuit by displaying the corresponding display color.

A toy, where the toy is paired and connected with the above-mentioned toy remote controllers, and the toy receives a control signal transmitted by the toy remote controller to perform a corresponding movement according to the control signal.

Furthermore, the toy is in the shape of an aircraft, a vehicle, or a boat.

The advantages of the present disclosure are as follows.

The present disclosure provides the voice sensor and the gravity sensor within the housing, so that the user can remotely control the toy by means of voice or shaking/swinging the toy remote controller, thereby realizing one-hand operation of the remote controller;

Simultaneously, the gravity sensor is located at the middle portion of the housing so as to increase the sensitivity of the gravity sensor, and at the same time avoiding the problem of easily damage of the gravity sensor in the case that the gravity sensor is mounted close to end portions.

The display unit changes the display color according to the control signal, so that the user can know the actual situation of the control of the toy remote controller on the toy, and the change of the display color can also improve the aesthetic feeling of the toy remote controller, thereby improving the user experience.

### BRIEF DESCRIPTION OF THE DRAWINGS

To describe the technical schemes in the embodiments of the present disclosure more clearly, the following briefly introduces the drawings required for describing the embodiments or the prior art. Apparently, the drawings in the following description merely show some examples of the present disclosure. For those skilled in the art, other drawings can be obtained according to the drawings without creative efforts.

FIG. 1 is a schematic block diagram of an embodiment of a toy remote controller according to present disclosure.

FIG. 2 is a side view of the structure of the toy remote controller of FIG. 1.

FIG. 3 is a cross-sectional view of the toy remote controller of FIG. 2.

FIG. 4 is a side view of the structure of another embodiment of a toy remote controller according to present disclosure.

FIG. 5 is a schematic block diagram of an embodiment of a speed control circuit according to present disclosure.

FIG. 6 is a schematic block diagram of another embodiment of a speed control circuit according to present disclosure.

### DETAILED DESCRIPTION

To further explain the technical means and effects of the present disclosure for achieving the intended inventive purposes, the present disclosure will be described in detail below with reference to the accompanying drawings and embodiments.

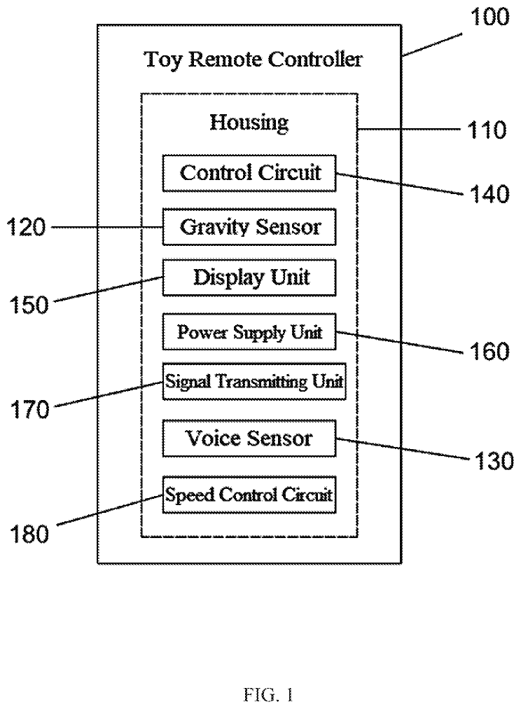

Referring to FIG. 1 to FIG. 6, the present disclosure provides a toy remote controller 100. FIG. 1 is a schematic block diagram of an embodiment of a toy remote controller according to present disclosure. As shown in FIG. 1, the toy remote controller 100 includes a display unit 150, a gravity sensor 120, a voice sensor 130, a control circuit 140, and a housing 110. In which, the display unit 150 is mounted upon the housing 110; the gravity sensor 120, the voice sensor 130, and the control circuit 140 are mounted within the housing 110, where the gravity sensor 120 is located at a middle portion of the housing 110. The control circuit 140 receives information through the gravity sensor 120 or the voice sensor 130 to generate a control signal. The display unit 150 is electrically coupled to the control circuit 140, and changes a display color of the display unit 150 according to the control signal.

In this embodiment, a user (i.e., the operator of the toy remote controller 100) may control the movement of a toy through the toy remote controller 100 which can be held and operated with one hand, and its operation is simple. Simultaneously, the user may control the movement of the toy by inclining the toy remote controller 100 or inputting voices, and its operation is intuitive and interesting. By combining the information of the movement of the arm or the voice, the user may control the toy by performing gesture changes or voice control.

Simultaneously, the gravity sensor 120 is located in the housing 110. When the user uses the toy remote controller 100, the swing amplitude of the gravity sensor 120 can be increased to increase the sensitivity of the gravity sensor 120. At the same time, the problem that the swinging amplitude of the gravity sensor 120 during the use of the user is excessive which causes the gravity sensor 120 to be easily damaged is also prevented.

The display unit 150 changes the display color according to the control signal of the control circuit 140, so that the user can know the control signal of the toy remote controller 100 with respect to the toy in real time, while the color change can improve the aesthetic feeling of the toy remote controller 100, thereby improving the user experience. In order to prevent the difference between the voice control and the motion control made by the user which will causes the display unit 150 unable to correctly indicate the control signal, the display unit 150 of the present disclosure performs color change only through the control signal of the control circuit 140, thereby ensuring that the user can know the control signal accurately through the display unit 150.

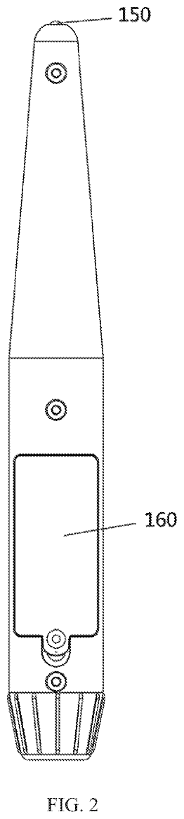

FIG. 2 is a side view of the structure of a the toy remote controller according to of FIG. 1 present disclosure. As shown in FIG. 2, the toy remote controller 100 further includes a power supply unit 160 and a signal transmitting unit 170. The power supply unit 160 provides power to the toy remote controller 100. The signal transmitting unit 170 is electrically coupled to the control circuit 140. The signal transmitting unit 170 transmits the control signal to the toy paired with the toy remote controller 100.

The control circuit 140 generates the control signal based on a gesture change information of the user which is obtained through the gravity sensor 120 or based on a voice information of the user which is obtained through the voice sensor 130.

In this embodiment, the signal transmitting unit 170 is an information transmitting terminal mounted on a circuit board of the control circuit 140, which may adopt a Bluetooth transmitting module or a 2.4G wireless module.

In the embodiment, the control circuit 140 receives motion information with respect to the user through the gravity sensor 120 and receives voice information with respect to the user through the voice sensor 130, and generates the corresponding control signal based on the received motion information or voice information. After the control signal is generated by the control circuit 140, it is transmitted to the signal transmitting unit 170 for matching with the toy so as to perform remote control. The present disclosure adopts the of motion control and voice control manners to control the toy, which increases the control manners of the user on the toy and has good user experience.

In this embodiment, the power supply unit 160 can utilize a rechargeable battery, a button battery, or a dry battery. When a rechargeable battery is used as the power supply unit 160, a charging port may be disposed on the housing 110 so as to charge the power supply unit 160.

In one embodiment, when the user moves the toy remote controller 100 forward by gesture, the display unit 150 displays a forward state and controls the toy to move forward; when the user moves the toy remote controller 100 backward by gesture, the display unit 150 displays a backward state and controls the toy to move backward; when the user moves the toy remote controller 100 leftward by gesture, the display unit 150 displays a leftward state and controls the toy to move leftward; and when the user moves the toy remote controller 100 rightward by gesture, the display unit 150 displays a rightward state and controls the toy to move rightward. In other embodiments, the toy remote controller 100 and its paired and connected toy use the same gestures and the same toy motion states. The toy can be, but is not limited to, a toy car, a toy boat, or a toy airplane.

When the user flips and vertically lowers the toy remote controller 100, the toy is controlled to stop, so that the movement of the toy is controlled and make an emergency stop.

When the toy remote controller 100 is placed in a fixed position for a preset duration and does not receive voice information or motion information, the toy remote controller 100 will automatically enter a sleep mode (i.e., a power saving mode) to save the power of the toy remote controller 100 and prolong the use of the battery, thereby improving the user experience. Specifically, the preset duration may be, but is not limited to, 5 minutes. For example, in other embodiments, the user may use other duration to put the toy remote controller 100 into the sleep mode according to the usage environment.

In an embodiment, for the above-mentioned control signal, the display manner of the display unit 150 may be as follows.

When the toy remote controller 100 is waved forwardly/downwardly or its received voice is a forward command, the display unit 150 displays green; when the toy remote controller 100 is waved backwardly or its received voice is a backward command, the display unit 150 displays yellow; when the toy remote controller 100 is waved leftwardly or its received voice is a leftward command, the display unit 150 displays purple; when the toy remote controller 100 is waved rightwardly or its received voice is a rightward command, the display unit 150 displays blue; and when the toy remote controller 100 is flipped or its received voice is a stop command, the display unit 150 displays red. In other embodiments, the user can allocate the displayed color and the control command according to the actual usage state, and the displayed color of the display unit 150 is not limited to the above-mentioned green, yellow, purple, blue, and red, and may allocate the displayed color according to the usage environment and the usage condition. All other schemes of matching the displayed color of the display unit 150 and the control signal are within the scope of the present disclosure.

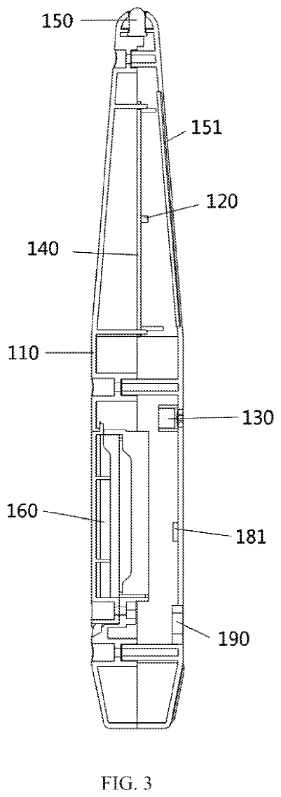

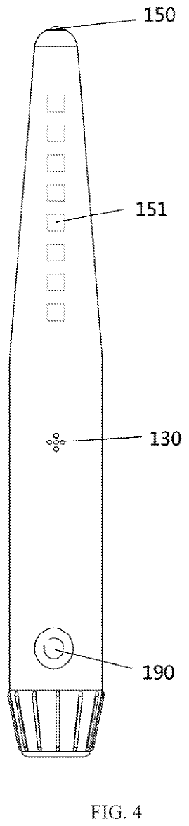

FIG. 3 is a cross-sectional view of the toy remote controller of FIG. 2; FIG. 4 is a side view of the structure of another embodiment of a toy remote controller according to present disclosure. As shown in FIG. 3 and FIG. 4, the toy remote controller 100 further includes a switch 190. The switch 190 is mounted upon the housing 110. The switch 190 can be used to selectively turn on and turn off the toy remote controller 110, and can be used to selectively switch the control circuit 140 to generate control signal through the gravity sensor 120 or selectively switches the control circuit to generate control signal through the voice sensor 130.

In this embodiment, the switch 190 in the toy remote controller 100 functions at two points: one is to turn the toy remote controller 100 on or off. At the same time, the user can also switch the manner in which the user uses the toy remote controller 100 by pressing the switch 190.

When the control circuit 140 in the toy remote controller 100 generates the control signal by receiving the information through the gravity sensor 120, the user remotely controls the toy by shaking the toy remote controller 100. When the user presses the switch 190, the gravity sensor 120 is turned off and the voice sensor 130 is turned on, the toy remote controller 100 generates the control signal based on voice information, and the user remotely controls the toy through voice commands. When the switch 190 is pressed again, the user switches the manner in which the toy is remotely controlled from voice control to control by shaking the toy remote controller 100.

In one embodiment, the manner in which the user operates the switch 190 is as follows.

When the user presses the switch 190 for a duration of more than 3 seconds, the toy remote controller 100 is turned on or off. If the toy remote controller 100 is turned on, the user can press the switch 190 to switch between the voice control and the shake control. The user can change the control manner of the toy remote controller 100 to the toy according to the usage environment, and the operation manner is simple and is convenient for the user to use.

The toy remote controller 100 further includes a speed control circuit 180. The speed control circuit 180 is electrically coupled to the control circuit 140.

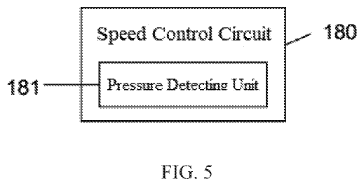

FIG. 5 is a schematic block diagram of an embodiment of a speed control circuit according to present disclosure. As shown in FIG. 5, the speed control circuit 180 includes a pressure detecting unit 181. The pressure detecting unit 181 obtains a pressure signal corresponding to a hand pressure of the user on the housing and transmits the pressure signal to the control circuit 140. The control circuit 140 obtains a speed control signal according to the pressure signal and transmits the speed control signal to the toy paired with the toy remote controller 100 to control a movement speed of the toy.

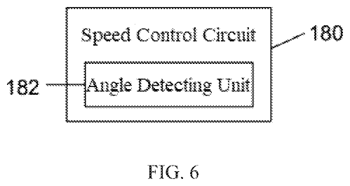

FIG. 6 is a schematic block diagram of another embodiment of a speed control circuit according to present disclosure. As shown in FIG. 6, the speed control circuit 180 includes an angle detecting unit 182. The angle detecting unit 182 is mounted within the housing 110. The angle detecting unit 182 detects an angle of inclination or swing of a top end of the housing to obtain a corresponding angle signal, and transmits the angle signal to the control circuit 140. The control circuit 140 processes the angle signal to obtain a speed control signal, and transmits the speed control signal to the toy paired with the toy remote controller 100 to control a movement speed of the toy.

In this embodiment, the angle detecting unit 182 measures the incline angle of the housing 100 through the gravity sensor 120. The gravity detector 120 is a gyroscope. During its use, the gyroscope will detect the incline angle of the housing 110 and the acceleration of the housing 110. When the user uses the toy remote controller 100, the swinging of the toy remote controller 100 will generate a force on the gyroscope and causes the gyroscope to obtain an acceleration, thereby obtaining the motion information of the user. At the same time, when the user inclines the toy remote controller 100, the angle of the gyroscope is shifted, and the detection position of the gyroscope is skewed so that the control circuit 140 can generate the corresponding speed control signal.

In this embodiment, the user can increase the traveling speed of the toy by increasing the incline angle or the pressing force with respect to the toy remote controller 100. Within the speed range of the toy, the larger the strength of the user to grip the housing 110 or the larger the incline angle, the faster the movement speed of the toy; the smaller the strength of the user to grip the housing 110 or the smaller the incline angle, the slower the movement speed of the toy. In this manner, the interaction between the toy and the user is enhanced, thereby improving the user experience.

In the present disclosure, the toy remote controller 100 is provided that the speed control circuit 180 in the toy remote controller 100 can control the traveling speed of the toy by adjusting the incline angle and the pressing force. The user is allowed to select according to the usage conditions, and the speed of the toy can be controlled by one of the above-mentioned two methods. It is convenient for the user to use and improves the user experience.

The housing 110 has a rod-like shape.

In one embodiment, a top portion of the housing 110 is obliquely formed as a tower shape, a middle portion of the housing 110 is formed as a cylindrical shape, and a tail portion of the housing 110 is formed in an oblique manner. The rod-like shaped housing 110 is only as an example. In other embodiments, the housing 110 may adopt other three-dimensional shapes such as a ring shape so as to enable the toy remote controller 100 to be applied to other environments.

The display unit 150 includes a display light 151. The display light 151 indicates the control signal of the control circuit 140 by displaying the corresponding display color.

In this embodiment, the display light 151 is mounted on a top end of the housing 110 to extend from the top end of the housing 110 toward the middle portion of the housing 110. The display light 151 adopts the structure extending from the top end of the housing 110 toward the middle portion of the housing 110 to facilitate the user to recognize the display light 151, and increases the visibility of the display light 151.

In this embodiment, the display light 151 in the display unit 150 may be an LED patch light which protrudes from the surface of the housing 110. A transparent patch light can also be used, where it is not displayed on the surface of the housing 110 when the light not illuminates, and is displayed on the surface of the housing 110 when the light illuminates. The display light 151 can be displayed in a manner of being constantly lit, blinking, or gradually brightening.

The present disclosure further provides a toy. In which, the toy is paired and connected with the above-mentioned toy remote controller 100 and receives a control signal transmitted by the toy remote controller 100 to perform a corresponding movement according to the control signal. The toy can be a remote control aircraft, a remote control vehicle, or a remote control boat.

In this embodiment, the toy can further be provided with a display unit to cooperate with the toy remote controller 100 to indicate the traveling direction of the toy, thereby improving the user experience.

In addition, the present disclosure further provides a computer readable storage medium. In which, the computer readable storage medium is stored with computer executable instructions. The computer readable storage medium may be, for example, a non-volatile memory such as an optical disk, a hard disk, or a flash memory. The above-mentioned computer executable instructions are used to cause a computer or similar computing device to perform various operations of the above-mentioned toy remote controller 100.

It should be understood that, the present disclosure is also applicable to various other embodiments. Based on the embodiments, other embodiments obtained by those skilled in the art without any creative work are within the scope of the present disclosure.

The forgoing is only the embodiments of the present disclosure, and is not intended to limit the scope of the present disclosure. The equivalent structure or equivalent process transformations made using the specification and the drawings of the present disclosure, or the directly or indirectly application to other related technologies, are all included in the scope of protection of the present disclosure.

What is claimed is:

1. A toy remote controller, comprising:
a display unit;
a gravity sensor;
a voice sensor;
a control circuit, wherein the display unit is electrically coupled to the control circuit; and
a housing, wherein the display unit is mounted upon the housing, the gravity sensor, the voice sensor, and the control circuit are mounted within the housing, the gravity sensor is located at a middle portion of the housing;
wherein, the control circuit receives information through the gravity sensor or the voice sensor to generate a control signal, and the display unit changes a display color according to the control signal.

2. The toy remote controller of claim 1, further comprising:
a power supply unit providing power to the toy remote controller; and
a signal transmitting unit electrically coupled to the control circuit, wherein the signal transmitting unit transmits the control signal to a toy paired with the toy remote controller;
wherein, the control circuit generates the control signal based on a gesture change information of a user obtained through the gravity sensor or based on a voice information of the user obtained through the voice sensor.

3. The toy remote controller of claim 1, further comprising a switch mounted upon the housing, wherein the switch selectively turns on and turns off the toy remote controller, and the switch further selectively switches the control circuit to generate the control signal through the gravity sensor or selectively switches the control circuit to generate control signal through the voice sensor.

4. The toy remote controller of claim 1, further comprising a speed control circuit electrically coupled to the control circuit.

5. The toy remote controller of claim 4, wherein the speed control circuit comprises a pressure detecting unit; wherein the pressure detecting unit obtains a pressure signal corresponding to a hand pressure of a user on the housing and transmits the pressure signal to the control circuit, and the control circuit obtains a speed control signal according to the pressure signal and transmits the speed control signal to a toy paired with the toy remote controller to control a movement speed of the toy.

6. The toy remote controller of claim 4, wherein the speed control circuit comprises an angle detecting unit mounted within the housing; wherein the angle detecting unit detects an angle of inclination or swing of a top end of the housing to obtain a corresponding angle signal, and transmits the angle signal to the control circuit; the control circuit processes the angle signal to obtain a speed control signal, and transmits the speed control signal to a toy paired with the toy remote controller to control a movement speed of the toy.

7. The toy remote controller of claim 1, wherein the housing has a rod-like shape.

8. The toy remote controller of claim 1, wherein the display unit comprises a display light; wherein the display light indicates the control signal in the control circuit by displaying the corresponding display color.

9. The toy remote controller of claim 1, wherein the control circuit receives motion information through the gravity sensor to generate the control signal based on the received motion information and receives voice information through the voice sensor to generate the control signal based on the received voice information.

10. A toy, wherein the toy is paired and connected with the toy remote controller of claim 1, and the toy receives a control signal transmitted by the toy remote controller to perform a corresponding movement according to the control signal.

11. The toy of claim 9, wherein the toy is in the shape of an aircraft, a vehicle, or a boat.
